(19) United States
(12) Patent Application Publication
(10) Pub. No.: US 2019/0387271 A1
(43) Pub. Date: Dec. 19, 2019

(54) IMAGE PROCESSING APPARATUS, IMAGE PROCESSING METHOD, AND PROGRAM

(71) Applicant: SONY CORPORATION, TOKYO (JP)

(72) Inventors: NAOTAKA OJIRO, KANAGAWA (JP); YOSHIYUKI KOBAYASHI, TOKYO (JP)

(21) Appl. No.: 16/470,819

(22) PCT Filed: Jan. 17, 2018
(86) PCT No.: PCT/JP2018/001093

§ 371 Date: Jun. 18, 2019

(30) Foreign Application Priority Data
Jan. 30, 2017 (JP) 2017-014119

(51) Int. Cl. H04N 21/438; H04N 21/433; H04N 21/845; H04N 21/43

(52) U.S. Cl. CPC H04N 21/4384; H04N 21/4302; H04N 21/8456; H04N 21/4331

(57) ABSTRACT

The present technology relates to an image processing apparatus, an image processing method, and a program that allow an improvement in response speed at the time of switching a stream. An image processing apparatus includes: a retention unit that retains, when performing switching of reproduction from reproduction based on first reproduction data to reproduction based on second reproduction data different from the first reproduction data, the first reproduction data from a reproduction time under reproduction that has been acquired to a prescribed reproduction time and the second reproduction data on and after a start time in which a reproduction time from the reproduction time under the reproduction of the first reproduction data to a last reproduction time of the first reproduction data that has been acquired is acquired as the start time. The present technology is applicable to a client apparatus.

### TECHNICAL FIELD

The present technology relates to an image processing apparatus, an image processing method, and a program and, in particular, to an image processing apparatus, an image processing method, and a program that allow an improvement in response speed at the time of switching a stream.

### BACKGROUND ART

For example, in MPEG-DASH (Moving Picture Experts Group phase—Dynamic Adaptive Streaming over HTTP) streaming reproduction, switching is performed at the boundary between segments when the switching of a stream occurs during the reproduction as in bit rate adaptation (see, for example, Non-Patent Literature 1). That is, the switching halfway through the segments is not assumed.

For example, when the length of the segments is ten seconds, the switching is made possible every ten seconds. This restriction also applies to a case in which multi-viewpoint distribution is realized on MPEG-DASH, and the frequency of occurrence of a boundary at which the switching of a viewpoint is allowed depends on the reproduction time of the segments.

Further, the reproduction of video and audio in MPEG-DASH streaming is performed on the basis of one decoder model in which each of the video and the audio has only one system at the same time.

### CITATION LIST

### Patent Literature

Non-Patent Literature 1: ISO/IEC 23009-1:2014 Information technology—Dynamic adaptive streaming over HTTP (DASH)—Part 1: Media presentation description and segment formats

### DISCLOSURE OF INVENTION

### Technical Problem

However, according to the above technology, a delay occurs due to switching at the boundary between the segments at the time of switching a stream, that is, at the time of switching the display of a content.

The present technology has been made in view of the above circumstances and allows an improvement in response speed at the time of switching a stream.

### Solution to Problem

An image processing apparatus according to an aspect of the present technology includes: a retention unit that retains, when performing switching of reproduction from reproduction based on first reproduction data to reproduction based on second reproduction data different from the first reproduction data, the first reproduction data from a reproduction time under reproduction that has been acquired to a prescribed reproduction time and the second reproduction data on and after a start time in which a reproduction time from the reproduction time under the reproduction of the first reproduction data to a last reproduction time of the first reproduction data that has been acquired is acquired as the start time.

The image processing apparatus can further include: an acquisition unit that acquires the second reproduction data on and after the start time.

The retention unit can discard the first reproduction data of a reproduction time after the prescribed reproduction time before or after starting acquisition of the second reproduction data.

The first reproduction data and the second reproduction data can be reproduction data having a same content and viewpoints different from each other.

The first reproduction data and the second reproduction data can be video data or audio data.

The acquisition unit can acquire the second reproduction data for each prescribed time unit.

The prescribed time unit can be a segment.

The acquisition unit can select the start time so that a time required to acquire the second reproduction data in the prescribed time unit with the start time as a start becomes shorter than the reproduction time of the first reproduction data from the reproduction time under the reproduction to the start time.

The acquisition unit can acquire the second reproduction data with a start position of synchronous reproduction data as the start time when a sum of a time required to acquire the synchronous reproduction data that is the second reproduction data in the prescribed time unit that has a same reproduction time as the first reproduction data in the prescribed time unit under reproduction and a time required until decode of the synchronous reproduction data catches up with the reproduction of the first reproduction data after the acquisition of the synchronous reproduction data is shorter than a reproduction time from the reproduction time under the reproduction to an end of the reproduction of the first reproduction data in the prescribed time unit under the reproduction.

The acquisition unit can acquire the second reproduction data having a bit rate lower than a bit rate of the first reproduction data under reproduction as the second reproduction data in the prescribed time unit with the start time as a start, and then acquires the second reproduction data having a higher bit rate in the prescribed time unit so that the bit rate of the acquired second reproduction data gradually increases.

The image processing apparatus can further include: an output unit that switches output reproduction data from the first reproduction data to the second reproduction data at a reproduction time between the reproduction time under the reproduction and the prescribed reproduction time.

The output unit can perform control so that a timing for switching an output from the first reproduction data to the second reproduction data as video data and a timing for switching an output from the first reproduction data to the second reproduction data as audio data become substantially same.

The acquisition unit can perform control so that at least parts of periods in which the first reproduction data and the second reproduction data at a same reproduction time are retained are overlapped with each other between the video data and the audio data.

The image processing apparatus can further include: an output unit that performs effect processing on a basis of the first reproduction data and the second reproduction data at a same reproduction time that are retained in the retention unit, and outputs reproduction data obtained by the effect processing.

An image processing method or a program according to an aspect of the present technology includes: a step of retaining, when performing switching of reproduction from reproduction based on first reproduction data to reproduction based on second reproduction data different from the first reproduction data, the first reproduction data from a reproduction time under reproduction that has been acquired to a prescribed reproduction time and the second reproduction data on and after a start time in which a reproduction time from the reproduction time under the reproduction of the first reproduction data to a last reproduction time of the first reproduction data that has been acquired is acquired as the start time.

In an aspect of the present technology, first reproduction data from a reproduction time under reproduction that has been acquired to a prescribed reproduction time and second reproduction data on and after a start time in which a reproduction time from the reproduction time under the reproduction of the first reproduction data to a last reproduction time of the first reproduction data that has been acquired is acquired as the start time are retained when switching of reproduction is performed from reproduction based on the first reproduction data to reproduction based on the second reproduction data different from the first reproduction data.

### Advantageous Effects of Invention

According to an aspect of the present technology, response speed can be improved at the time of switching a stream.

Note that the effects described here are not limitative and any effect described in the present disclosure may be produced.

### BRIEF DESCRIPTION OF DRAWINGS

FIG. 1 is a diagram for describing the switching of a viewpoint.

FIG. 2 is a diagram for describing a deviation in the switching time between video and audio.

FIG. 3 is a diagram showing a configuration example of a client apparatus.

FIG. 4 is a diagram for describing the selection of a segment of a switching destination.

FIG. 5 is a diagram for describing the selection of a segment of the switching destination.

FIG. 6 is a diagram for describing the selection of a segment of the switching destination.

FIG. 7 is a diagram for describing the selection of a segment of the switching destination.

FIG. 8 is a diagram for describing cache management.

FIG. 9 is a diagram for describing the cache management.

FIG. 10 is a diagram for describing the determination of a switching point.

FIG. 11 is a flowchart for describing download processing.

FIG. 12 is a flowchart for describing decode processing.

FIG. 13 is a diagram showing a configuration example of a computer.

### MODE(S) FOR CARRYING OUT THE INVENTION

Hereinafter, embodiments to which the present technology is applied will be described with reference to the drawings.

### First Embodiment

<Present Technology>

The present technology aims to allow response speed at the time of switching a stream to be increased when the reproduction of multi-viewpoint switching or the like is performed in MPEG-DASH streaming distribution. Further, the present technology allows a sense of discomfort occurring in a viewing experience to be reduced by download processing or buffer management.

Note that the present technology is applicable not only to moving image reproduction such as MPEG-DASH streaming distribution but also to VR (Virtual Reality) or the like. However, a description will be continued using a case in which the present technology is applied to the MPEG-DASH streaming distribution as an example.

When MPEG-DASH is applied to multi-viewpoint moving image distribution, a delay occurs until a video content that is being reproduced is actually switched relative to a time at which a switching request has been issued from a user by a remote commander or the like under the constraint that a display is switched at the boundary between segments. For example, a delay of ten seconds or more could possibly occur depending on the content production of a server and the packaging of a client player.

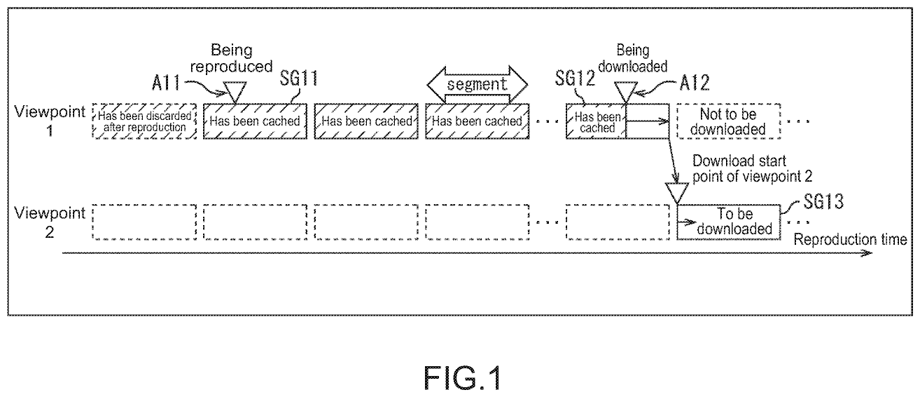

As an example, it is assumed that, when a portion indicated by an arrow A11 in a segment SG11 of a viewpoint 1 of a content is being reproduced as shown in, for example, FIG. 1, the switching of a display from the viewpoint 1 to a viewpoint 2 has been instructed. Further, it is assumed that a download has been completed up to a portion indicated by an arrow A12 of a segment SG12 as for the stream of the viewpoint 1 at this point, and that portions from the segment SG11 to the portion indicated by the arrow A12 of the segment SG12 have been cached. Note that in FIG. 1, a horizontal direction indicates a time, and each square indicates a segment.

In general, a client apparatus downloads and caches one or more segment data in advance. When actually reproducing the segment data, the client apparatus acquires video data or audio data from a cache while parsing the same and supplies the acquired data to a decoder. After that, the client apparatus performs drawing processing or the like.

Here, a cached amount of the segment data is different depending on the packaging of the client apparatus, but it is general to cache the segment data for at least about several seconds to several tens of seconds from a time under reproduction.

Further, at the time of switching the display, it is general to transition to the viewpoint 2 after reproducing all the cached segments of the viewpoint 1.

Accordingly, in this example, when switching to the viewpoint 2 is instructed during the reproduction of the portion indicated by the arrow A11, the client apparatus starts the download of a segment SG13 of the viewpoint 2 following the segment SG12 after completing the download of the segment SG12. Then, when the reproduction of the video data of the viewpoint 1 ends up to the terminal portion of the segment SG12, the display is switched to the viewpoint 2 to start the reproduction of the video data from the start portion of the segment SG13.

However, if the transition to the viewpoint 2 is made after the end of the reproduction of the cached segments of the viewpoint 1 as described above, a time lag until the display is actually switched after a user performs a switching operation is too large. Therefore, such switching of the display is not practical. In this case, the user is not allowed to recognize whether the instructions for switching the display have been properly received if the time lag is large, and thus could possibly perform an unnecessary operation.

In view of this problem, as a method for reducing, for example, a delay in the switching of the display and improving a response (response speed), it is assumed that the length of the segments is extremely shortened to, for example, 0.5 seconds or the like when a content is produced on a distribution server side. In this case, the cycle of reaching the boundary between the segments at which the switching of the display is allowed reduces, which makes it possible to increase response speed on a bodily sensation.

However, this method has many disadvantages such as a reduction in viewing quality due to an influence on encode image quality and an increase in the processing of the server side or the burden of storage management due to an increase in the number of segment data.

Therefore, the present technology introduces new download management and a new cache management method into a client apparatus without adding modifications while maintaining the current system of a content distribution side to allow an improvement in response speed at the time of switching a display.

Further, in multi-viewpoint video distribution, there are a case in which one type of audio is added to a plurality of video viewpoints and a case in which audio matching each video is prepared for each of a plurality of video viewpoints.

For example, it is assumed that the former case is applied to music video or the like that is viewed as a work, and that the latter case is applied to live distribution or the like that places importance on a sense of realism.

When audio is switched simultaneously with the switching of the viewpoint of video in MPEG-DASH streaming reproduction, the switching of the video and the audio is basically processed in separate thread processing and the switching timings of the video and the audio are separately calculated and determined. Accordingly, it is not assumed that the switching timings of the video and the audio are synchronized with each other, and a temporal deviation occurs at a switching point.

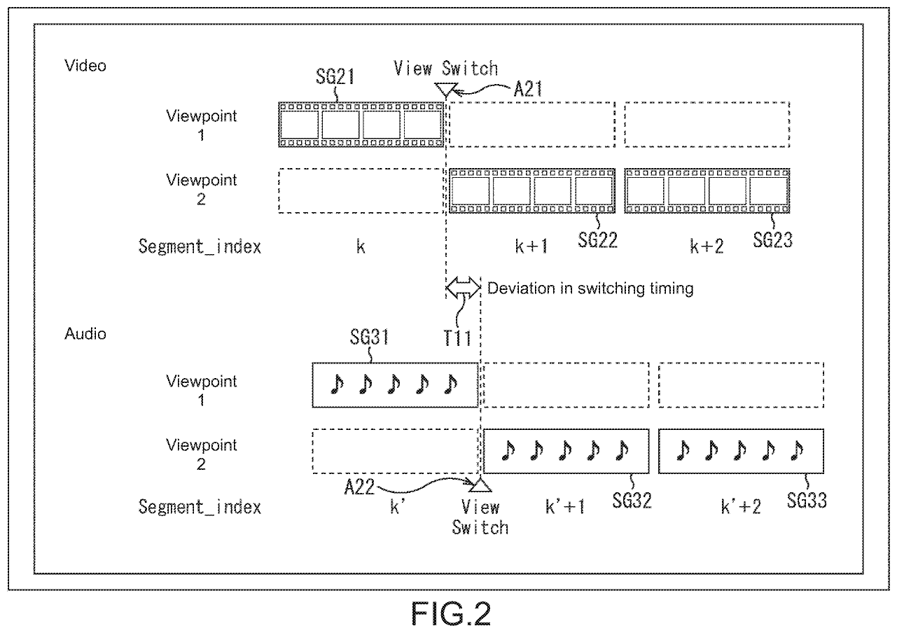

As shown in, for example, FIG. 2, it is assumed that a segment SG21 of the video of a viewpoint 1 and a segment SG31 of the audio of the viewpoint 1 are simultaneously reproduced as a content.

Note that in FIG. 2, a horizontal direction indicates a time, and each square indicates a segment. Further, in FIG. 2, characters “k,” “k+1,” and “k+2” indicate indexes for identifying video segments, and characters “k′,” “k′+1,” and “k′+2” indicate indexes for identifying audio segments.

In an example shown in FIG. 2, it is assumed that the switching of the viewpoint has been instructed during the reproduction of the segment SG21 of the viewpoint 1. At this time, as for the video, the viewpoint is switched at a position indicated by an arrow A21 after the reproduction of the segment SG21, and then a segment SG22 of a viewpoint 2 and a segment SG23 of the viewpoint 2 are reproduced one after the other.

Further, as for the audio, the viewpoint is switched at a position indicated by an arrow A22 after the reproduction of a segment SG31 of the viewpoint 1, and then a segment SG32 of the viewpoint 2 and a segment SG33 of the viewpoint 2 are reproduced one after the other.

However, since the boundary position between the video segments is different from the boundary position between the audio segments in this example, a deviation occurs in the switching time between the video and the audio when the viewpoint 1 is switched to the viewpoint 2.

That is, in this example, the viewpoint 1 is switched to the viewpoint 2 at the time indicated by the arrow A21 as for the video, while the viewpoint 1 is continuously reproduced at the time indicated by the arrow A21 as for the audio. Then, at the time indicated by the arrow A22 following the time indicated by the arrow A21, the viewpoint 1 is switched to the viewpoint 2 as for the audio. Accordingly, a deviation occurs in the switching time between the video and the audio by the length of the time of a period T11.

In general, even if packaging has been made so that processing for intentionally adjusting the boundary positions of the segment at which the viewpoint is switched to come close to each other between video and audio, the video and the audio have different sample rates. Therefore, points at which the segments can be divided are also different depending on the encoding conditions of the video and the audio, or the like. Accordingly, it is, after all, difficult to set the positions of the segment boundaries at the same time between the video and the audio at the time of producing a content.

From this reason, in the case of the packaging based on the switching at the boundaries of the segments, it is almost impossible to match the switching timings between the video and the audio each other at a level at which a sense of discomfort does not occur on a bodily sensation. Even if the segment boundary of the video and the segment boundary of the audio are coincidentally set at timings (positions) close to each other to such an extent that a sense of discomfort does not occur, a satisfactory result is not necessarily obtained in response to a user's operation performed at any timing. Therefore, as for the simultaneous switching of the video and the audio, a fundamental solution cannot be found so long as the switching is performed at the boundaries of the segments.

Therefore, the present technology introduces a cache management method with which the switching of a stream can be realized halfway through a segment to allow a reduction in the deviation of switching timings between video and audio and a reduction in a sense of discomfort occurring when a content is viewed.

In addition, when the video viewpoint of a content is suddenly switched as a viewing experience, it is sometimes difficult to determine whether the switching is made by the editing of video or made in response to a user's operation.

Particularly, in a case in which adjacent camera viewpoints are switched to each other, a case in which a camera that captures an image moves like a case in which a camera position itself moves due to a camera operation such as pan, tilt, and zoom, a crane, or the like, it is really difficult for a viewer to determine whether a viewpoint is switched or edited as initially set. Therefore, the user is not allowed to recognize the switching, and thus could possibly press an operation button many times. If the user is absorbed in anything other than content viewing as described above, an immersion feeling as a viewing experience is impaired.

In order to address this problem, it is generally assumed that a character string, an icon, or the like is displayed on a screen (On-Screen Display) to perform the announcement of switching. However, such an on-screen display could possibly impair an immersion feeling during the viewing of a content.

Therefore, the present technology introduces the application of a video effect such as a transition effect including, for example, cross fade or wipe lasting for about several seconds and cache management for realizing such a video effect to allow a user to easily recognize the switching of a viewpoint or the like without impairing an immersion feeling.

Further, the quality of audio is reduced when the audio is suddenly switched, whereby an immersion feeling may be impaired. For example, in general, when less correlated audio signals are connected to each other, noise is likely to be generated at a discontinuous point. Therefore, when the correlation between the audio signals before and after switching is low, the quality of reproduced audio may be reduced due to the generation of noise.

Therefore, the present technology introduces the same cache management as that for video to allow a noise countermeasure audio effect such as cross fade of audio signals and a reduction in the impairment of an immersion feeling.

<Configuration Example of Client Apparatus>

Next, a more specific embodiment of the client apparatus to which the present technology is applied will be described.

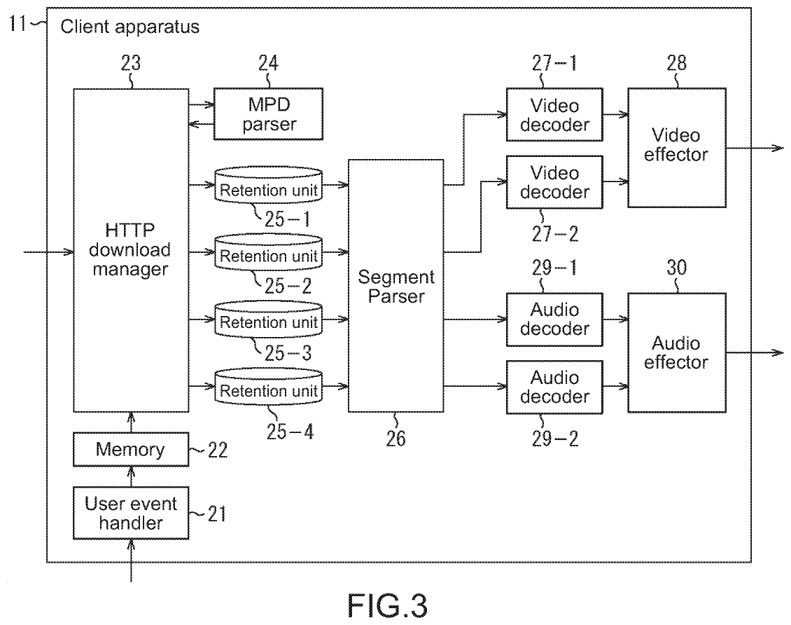

FIG. 3 is a diagram showing a configuration example of an embodiment of the client apparatus to which the present technology is applied.

A client apparatus 1 shown in FIG. 3 is a reproduction apparatus that downloads the segment data of a content from a server not shown, and that controls the reproduction of the content composed of at least video among the video and audio.

In the client apparatus 11, reproduction data such as the video data or the audio data of a content in downloading, the following processing, or the like is basically handled for each prescribed time unit called a segment, that is, for each prescribed frame number.

Further, the reproduction data items of respective viewpoints acquired (downloaded) and reproduced by the client apparatus 11 are reproduction data items having reproduction times corresponding to each other and correlated with each other.

Here, since it is assumed that the reproduction data items of the respective viewpoints are the reproduction data items of the same content and viewpoints different from each other, the reproduction data items have correlation in that they are related to the same content. Further, the reproduction data items of the respective viewpoints mutually have the portion of the same reproduction time. For example, when the reproduction data items are video data items, the reproduction time of the respective video data items is the CTS (Composition Time Stamp) of a video frame contained in video segment data, or the like.

Note that reproduction data items different from each other that are handled by the client apparatus 11 and are to be switched to be reproduced are not limited to the reproduction data items of respective viewpoints, but may include any reproduction data items so long as they have reproduction times corresponding to each other and have correlation.

The client apparatus 11 has a user event handler 21, a memory 22, a HTTP (Hypertext Transfer Protocol) download manager 23, a MPD (Media Presentation Description) parser 24, a retention unit 25-1, a retention unit 25-2, a retention unit 25-3, a retention unit 25-4, a segment parser 26, a video decoder 27-1, a video decoder 27-2, a video effector 28, an audio decoder 29-1, an audio decoder 29-2, and an audio effector 30.

Upon receiving an operation by a user to instruct the switching of a viewpoint, the user event handler 21 supplies a viewpoint switching request corresponding to the operation to the memory 22 to be retained.

The memory 22 retains the viewpoint switching request supplied from the user event hander 21. That is, the memory 22 inputs (stacks) the supplied viewpoint switching request to (in) an event queue to retain the same.

The HTTP download manager 23 downloads (receives) a MPD file from a server and supplies the downloaded (received) MPD file to the MPD parser 24 or downloads (receives) segment data from the server and supplies the downloaded (received) segment data to any of the retention units 25-1 to 25-4 on the basis of the control of the MPD parser 24 or the viewpoint switching request retained in the memory 22. That is, the HTTP download manager 23 functions as an acquisition unit that acquires the segment data or the like from the server.

Here, the MPD file is data in which metadata for managing the segment data of the video (moving image) or the audio of a content is described.

Further, the HTTP download manager 23 controls the stack of the segment data in the caches of the retention units 25-1 to 25-4 or manages the caches.

The MPD parser 24 controls the HTTP download manager 23 on the basis of the MPD file supplied from the HTTP download manager 23 and causes the HTTP download manager 23 to download (acquire) the segment data from the server.

The retention units 25-1 to 25-4 are constituted by, for example, memories or the like, temporarily retain the segment data supplied from the HTTP download manager 23, and supplies the retained segment data to the segment parser 26. That is, the retention units 25-1 to 25-4 stack the segment data in the caches according to the control of the HTTP download manager 23.

For example, the segment data of video data (moving image data) to be supplied to the video decoder 27-1 is supplied to the retention unit 25-1, and the segment data of video data to be supplied to the video decoder 27-2 is supplied to the retention unit 25-2.

Further, the segment data of audio data to be supplied to the audio decoder 29-1 is supplied to the retention unit 25-3, and the segment data of audio data to be supplied to the audio decoder 29-2 is supplied to the retention unit 25-4.

Note that the retention units 25-1 to 25-4 will also simply be called retention units 25 below when they are not particularly required to be distinguished from each other. Further, in the above example, the four retention units 25 are provided in total for the video and the audio. However, the four retention units 25 may be realized by one memory.

The segment parser 26 appropriately reads the segment data (segment files) stacked in the caches of the retention units 25-1 and 25-2 to extract the video data to be reproduced from the segment data and supplies the extracted video data to the video decoders 27-1 and 27-2.

Further, the segment parser 26 appropriately reads the segment data stacked in the caches of the retention units 25-3 and 25-4 to extract the audio data to be reproduced from the segment data and supplies the extracted audio data to the audio decoders 29-1 and 29-2.

The video decoders 27-1 and 27-2 decode the video data supplied from the segment parser 26 and supplies the decoded video data to the video effector 28. Note that the video decoders 27-1 and 27-2 will also simply be called video decoders 27 below when they are not particularly required to be distinguished from each other.

The video effector 28 appropriately processes the video data supplied from the video decoders 27 into data shaped to be finally output to a subsequent apparatus such as an image monitor and outputs the resulting video data as video data for presentation. That is, the video effector 28 functions as an output unit that outputs the video data for presentation.

For example, the video effector 28 directly outputs the video data supplied from the video decoders 27 as the video data for presentation. Alternatively, the video effector 28 applies effect processing to the video data supplied from the video decoders 27 and outputs the resulting video data as the video data for presentation.

The audio decoders 29-1 and 29-2 decode the audio data supplied from the segment parser 26 and supplies the decoded audio data to the audio effector 30. Note that the audio decoders 29-1 and 29-2 will also simply be called audio decoders 29 below when they are not particularly required to be distinguished from each other.

The audio effector 30 appropriately processes the audio data supplied from the audio decoders 29 into data shaped to be finally output to a subsequent apparatus such as an audio DAC (Digital to Analog Converter) and an amplifier and outputs the resulting audio data as audio data for presentation. That is, the audio effector 30 functions as an output unit that outputs the audio data for presentation.

For example, the audio effector 30 directly outputs the audio data supplied from the audio decoders 29 as the audio data for presentation. Alternatively, the audio effector 30 applies effect processing to the audio data supplied from the audio decoders 29 and outputs the resulting audio data as the audio data for presentation.

<Download Processing and Cache Management>

Subsequently, download processing for segment data and cache management in the client apparatus 11 will be described.

In the client apparatus 11, the download processing and the cache management that will be described below are performed so that a viewpoint is more quickly switched after a user performs an operation to instruct the switching of the viewpoint at the time of switching the viewpoint of a content.

That is, in the client apparatus 11, the download processing in which a proper segment of the viewpoint of a switching destination is selected and the cache management in which the segment data items of two viewpoints reproduced at the same time are simultaneously retained for a certain period of time are performed.

First, the download processing performed in the client apparatus 11 will be described.

For example, it is assumed that, when a content is reproduced, the reproduction is switched from the segment of a viewpoint 1 to the segment of a viewpoint 2 of the same content. In such a case, in order to realize the switching at an earlier timing, the selection of the segment of the viewpoint 2 that is to be downloaded becomes important.

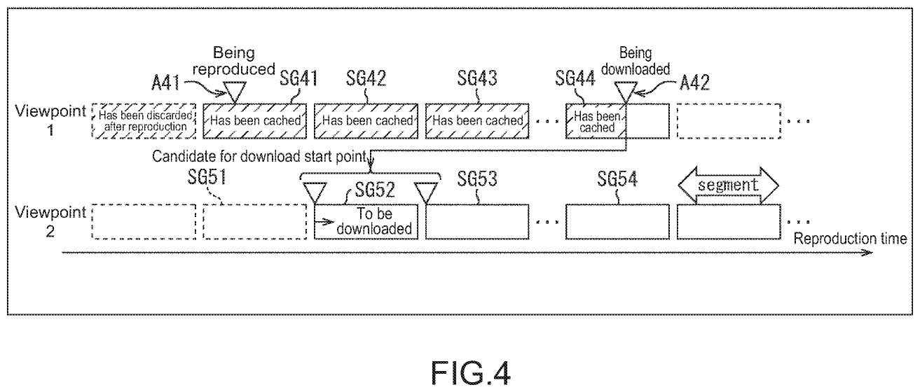

In the client apparatus 11, in order to quickly transition to the viewpoint 2 without reproducing all the segments of the existing caches of the viewpoint 1 as shown in, for example, FIG. 4, the download of the segment data of the viewpoint 1 is immediately stopped after the issuance of a switching request by the user. Note that in FIG. 4, a horizontal direction indicates a time, particularly the reproduction time of the content, and each square indicates a segment.

In this example, a portion indicated by an arrow A41 of a segment SG41 is being reproduced at the present time as for the viewpoint 1. That is, on the basis of the segment data of the segment A41, it is assumed that the portion at a reproduction time indicated by the arrow A41 of the viewpoint 1 is being reproduced.

Further, the download of a plurality of segments including the segment SG41 to a segment SG43 and a part of a segment SG44 has been completed. In addition, the segment data of a portion indicated by an arrow A42 of the segment SG44 is being downloaded at the present time.

When the switching request from the viewpoint 1 to the viewpoint 2 is issued in such a state, the download of the segment SG44 is stopped and the first segment to be downloaded of the viewpoint 2 is determined (selected) in the client apparatus 11. Then, the download of the segment of the viewpoint 2 is started according to the determination. Hereinafter, the segment to be initially downloaded of the viewpoint after the switching will also be called a start segment.

Here, the segment of the viewpoint 2 that has the same reproduction time as the segment SG41 of the viewpoint 1 that is being reproduced is a segment SG51.

In this example, it is assumed that a segment SG52 of the viewpoint 2 that has the same reproduction time as the segment SG42 next to the segment SG41 of the viewpoint 1 that is being reproduced and a segment SG53 next to the segment SG52 are set as candidates for start segments to be downloaded.

When the download of the segment of the viewpoint 2 that becomes the first candidate for a start segment is not completed until the end of the reproduction of the segment SG41 such as when the reproduction of the segment SG41 of the viewpoint 1 that is being reproduced is almost completed, the next segment is set as a candidate.

Accordingly, in this example, when the download of the segment SG52 that becomes the first candidate for the start segment of the viewpoint 2 is not completed until the end of the reproduction of the segment SG41 of the viewpoint 1, the next segment SG53 is set as a candidate for a start segment.

Note that in order to quickly switch the reproduction from the viewpoint 1 to the viewpoint 2, segments from the segment SG51 of the viewpoint 2 that has the same reproduction time as the segment SG41 that is being reproduced to a segment SG54 of the viewpoint 2 that has the same reproduction time as the segment SG44 of the viewpoint 1 that has been downloaded may only be set as start segments.

In other words, in the HTTP download manager 23, a proper reproduction time from a reproduction time at which the segment SG41 is being reproduced to the last reproduction time of the segment SG44 that has been downloaded (acquired) and retained in the retention units 25 may only be selected as a start time. In this case, the segment of the viewpoint 2 that starts at the selected start time is set as a start segment, and the segment data of segments on and after the start segment is downloaded.

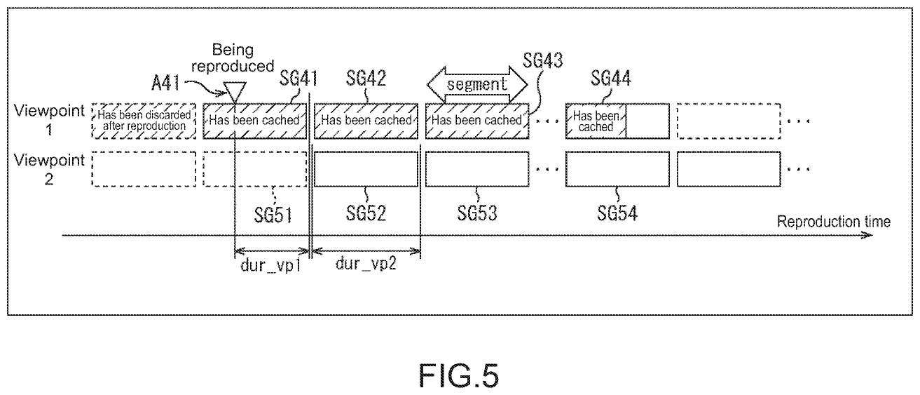

Here, the determination of a start segment will be described in further detail with reference to FIGS. 5 to 7. Note that the portions of FIGS. 5 to 7 corresponding to those of FIG. 4 will be denoted by the same symbols and their descriptions will be appropriately omitted.

As shown in, for example, FIG. 5, it is assumed that segments SG52 and SG53 of a viewpoint 2 are candidates for start segments. It is assumed that a position (reproduction time) at which the segment SG41 is being reproduced will also be called a reproduction point, and that a position (reproduction time) at which the reproduction is switched to the viewpoint 2 will also be called a switching point. In this example, it can be said that the switching point is a reproduction time that becomes the start position of the initially-acquired segment data of the viewpoint of a switching destination, that is, a reproduction time (start time) at which the acquisition of the segment data is started.

Note that the switching point may be either the start position of the segment of the viewpoint of the switching destination or a position halfway through the segment of the viewpoint of the switching destination.

Further, it is assumed that the reproduction time of the content of the viewpoint of a switching source (before switching) from the reproduction point that is the reproduction time under the reproduction to the switching point at which a candidate for a start segment is set as an actual start segment will also be called a reproduction time dur_vp1. In addition, it is assumed that a time required to download the segment data of a segment that is a candidate for a start segment will also be called a download time dur_vp2.

In FIG. 5, the reproduction time dur_vp1 and the download time dur_vp2 in a case in which it is assumed that the segment SG52 is set as a start segment are shown.

That is, in this example, the length of a period from the reproduction point indicated by the arrow A41 to the start position of the segment SG52 that is set as a switching point, that is, the boundary position between the segments G41 and G42 is the reproduction time dur_vp1. Further, a time until the completion of the download of the segment data of the segment SG52 after the download of the segment SG44 is stopped is set as the download time dur_vp2.

In the client apparatus 11, a start segment is selected so that the download time dur_vp2 becomes shorter than the reproduction time dur_vp1. At this time, a segment having the earliest reproduction time among segments of which the download time dur_vp2 becomes shorter than the reproduction time dur_vp1 is selected as a start segment.

In an example shown in FIG. 5, the segment SG52 is selected as a start segment when the download time dur_vp2 of the segment SG52 becomes shorter than the reproduction time dur_vp1.

On the other hand, the segment SG52 is not selected as a start segment, for example, when the download time dur_vp2 of the segment SG52 becomes longer than the reproduction time dur_vp1.

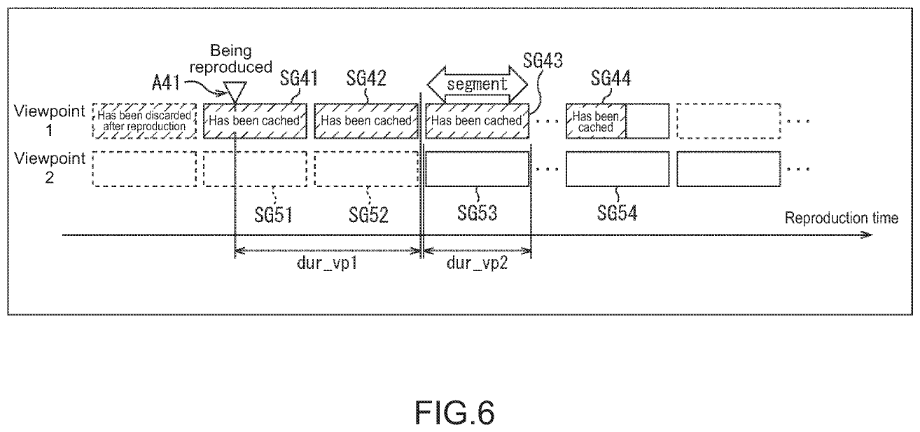

In this case, as shown in, for example, FIG. 6, the download time dur_vp2 of the segment SG53 and the reproduction time dur_vp1 are compared with each other.

In an example shown in FIG. 6, the length of a period from the reproduction point indicated by the arrow A41 to the start position of the segment SG53 that is set as a switching point, that is, the boundary position between the segments G42 and G43 is set as the reproduction time dur_vp1. Further, a time until the completion of the download of the segment data of the segment SG53 after the download of the segment SG44 is stopped is set as the download time dur_vp2.

In this case, the segment SG53 is selected as a start segment when the download time dur_vp2 of the segment SG53 becomes shorter than the reproduction time dur_vp1.

Note that when the viewpoint 1 that is the switching source is switched to the viewpoint 2 that becomes the switching destination, a start segment having quality such as resolution the same as that of the segment of the viewpoint 1 that is the switching source is set as a candidate to be downloaded as the start segment of the viewpoint 2.

However, in a case in which importance is attached to an immediate response at the time of switching a viewpoint, a segment for bitrate adaptation of the viewpoint 2 may be set as a candidate to be downloaded in order to shorten a download time. That is, although the segment of the same viewpoint 2 that has the same reproduction time is selected, it is also possible to select a start segment from a representation having a lower bit rate as the segment of the viewpoint 2 that is to be reproduced immediately after the switching of the viewpoint. In this case, after the viewpoint 1 is switched to the viewpoint 2, the segment that is to be downloaded and reproduced may only be returned (switched) to a segment having a higher bit rate, that is, a segment having higher quality.

For example, it is assumed that, when the segment SG52 is set as a start segment, the download of the segment SG52 is not completed until the reproduction of a switching point ends even if a segment having the same bit rate as that of the segment SG41 is downloaded as the segment SG52.

However, in this case, if a segment having a bit rate lower than that of the segment SG41, that is, a segment having lower quality is selected as the segment SG52, the download of the segment may be completed until the reproduction of the switching point ends.

In such a case, if the segment SG52 is set as a start segment and a segment having a bit rate lower than that of the segment SG41 is downloaded as the segment SG52, the viewpoint can be more quickly switched.

In this case, for example, a segment having a bit rate higher than that of the segment SG52 may only be downloaded as the segment SG53 following the segment SG52, and then a segment having the same bit rate as that of the first segment SG41 may only be downloaded as the next segment SG54.

As described above, a segment having a bit rate lower than that of a segment before the switching of a viewpoint is downloaded immediately after the switching, then a segment having a higher bit rate, that is, a segment having an increased bit rate is gradually downloaded, and finally a segment having the same bit rate as that of the segment before the switching is downloaded. In the manner described above, the viewpoint can be quickly switched.

Note that a plurality of representations are generally prepared for one adaptation set, and the segment data items of the representations are segment data items that have the same viewpoint and the same reproduction time but have bit rates different from each other. Therefore, in the client apparatus 11, a desired representation is selected (specified) with respect to the server, whereby segment data having a target bit rate can be downloaded.

Further, even if the segment SG51 of the viewpoint 2 that has the same reproduction time as that of the segment SG41 that is being reproduced is set as a start segment, the download of the segment may be completed before the switching of the viewpoint.

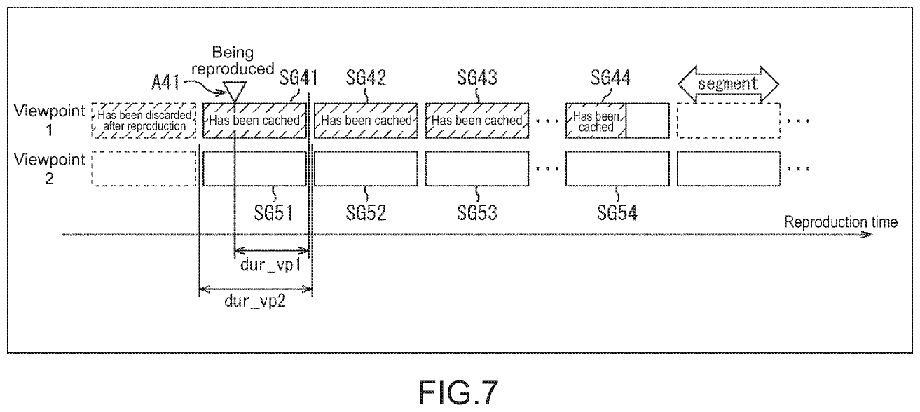

As shown in, for example, FIG. 7, the length of a period from the reproduction point indicated by the arrow A41 to the position of the segment SG51 that is a switching point becomes the reproduction time dur_vp1 when it is assumed that the segment SG51 is a candidate for a start segment. At this time, the reproduction time dur_vp1 becomes the longest when the switching point is set at the terminal position of the segment SG51, that is, when the switching point is set at the boundary position between the segments 41 and 42.

Further, a time until the download of the segment SG51 is completed after the stop of the download of the segment SG44 is set as the download time dur_vp2.

Here, it is assumed that the download and the decode of the segment SG51 are performed while the reproduction of the segment SG41 is continuously performed. At this time, it is assumed that a time until the decode of the segment SG51 catches up with the position of the segment SG41 of the viewpoint 1 that is being reproduced after the download of the segment SG51 of the viewpoint 2 is a decode time dur_vp3.

That is, the decode time dur_vp3 indicates a time required until the position (reproduction time) of the segment SG51 at which the decode has been completed reaches the position (reproduction time) of the segment SG41 that is being continuously reproduced after the start of the decode of the segment SG51.

Note that when the position of the segment SG51 of the switching destination (after the switching) at which the decode has been completed reaches the position of the segment SG41 of the switching source (before the switching) that is being reproduced, the position of the segment SG41 that is being reproduced will also be called a decode complete time reproduction point below.

However, in this case, the decode complete time reproduction point is required to be a position on a side closer to the reproduction point than the reproduction end position of the segment SG41, that is, the terminal position of the segment SG41. Accordingly, in this example, the decode complete time reproduction point is a reproduction time between the reproduction point and the terminal position of the segment SG41.

Specifically, for example, it is assumed that, when the reproduction of the segment SG41 is continuously performed, the decode of the segment SG51 is completed from the start of the segment SG51 to a reproduction time tc at a point at which the reproduction of the segment SG41 ends until the reproduction time tc. In this case, the reproduction time tc becomes the decode complete time reproduction point.

For example, when the sum of the download time dur_vp2 and the decode time dur_vp3 becomes shorter than a reproduction time from the reproduction point to the terminal position of the segment SG41, more specifically, when the sum becomes shorter than the reproduction time dur_vp1, the segment SG51 of the viewpoint 2 is put into a reproducible state before the end of the reproduction of the segment SG41 of the viewpoint 1. In other words, the sum of the download time dur_vp2 and the decode time dur_vp3 may only become shorter than a reproduction time from the reproduction point to the decode complete time reproduction point.

Accordingly, in such a case, the segment SG51 is set as a start segment, and a position halfway through the segment SG51, that is, the decode complete time reproduction point or the position of a subsequent reproduction time can be set as a switching point.

Note that when effect processing or the like is performed on the basis of the segment of the viewpoint 1 and the segment of the viewpoint 2 having the same reproduction time as that of the segment of the first viewpoint at the time of switching the segment from the viewpoint 1 to the viewpoint 2, it is required to select a start segment or a switching point by considering whether the effective time of the effect processing or the like lasts until the reproduction of the segment of the viewpoint 1 of the switching source ends.

That is, when the effect processing or the like is performed at the time of switching the viewpoint, a time from the decode complete time reproduction point to the end of the reproduction of the segment of the viewpoint 1 of the switching source that is being reproduced is required to be longer than a time (effective time) until the viewpoint 1 is completely switched to the viewpoint 2 after the start of the effect or the like.

However, when a segment next to a segment that is being reproduced has been cached as the segment of the viewpoint of the switching source, a timing at which the reproduction of the segment is completely switched to the viewpoint 2 may be set at a position inside the segment next to the segment that is being reproduced. In such a case, the cached segment of the viewpoint 1 of the switching source may only be retained without being discarded, and a time from the decode complete time reproduction point to the end of the reproduction of the segment of the viewpoint 1 of the switching source that is being reproduced may be shorter than a time (effective time) until the viewpoint 1 is completely switched to the viewpoint 2 after the start of the effect or the like.

Further, in the example described with reference to FIGS. 5 and 6 as well, a position halfway through the start segment may be set as a switching point instead of the start position of the start segment.

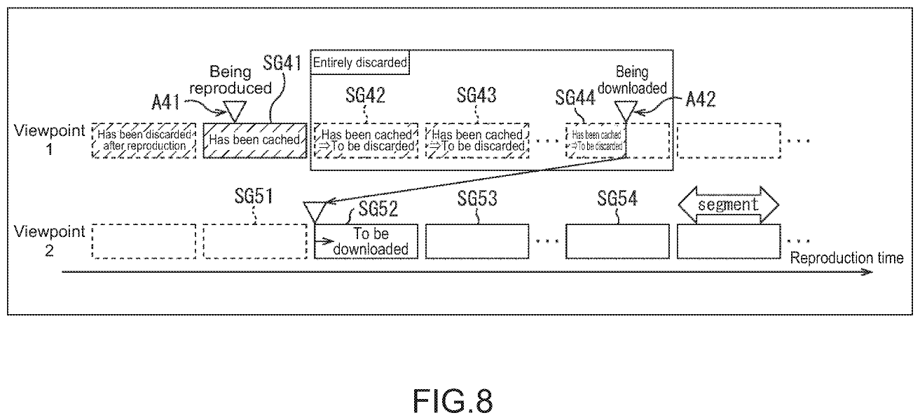

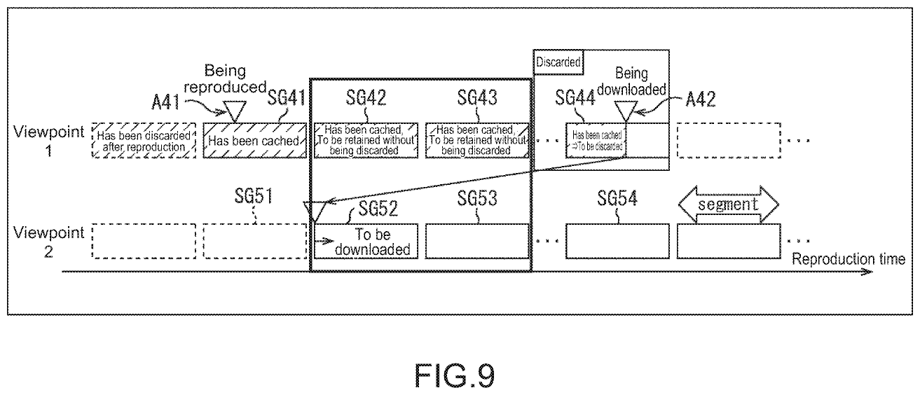

Next, the cache management in the client apparatus 11 will be described with reference to FIGS. 8 and 9. Note that the portions of FIGS. 8 to 9 corresponding to those of FIG. 4 will be denoted by the same symbols and their descriptions will be appropriately omitted.

As shown in, for example, FIG. 8, it is assumed that a viewpoint switching request has been issued during the reproduction of a segment SG41 of a viewpoint 1, and that the download of the segment data of segments SG52 and SG53 has been started with the segment SG52 as a start segment.

In this case, the segment data of the viewpoint 1 that has been cached may be discarded as unnecessary segment data at a point at which the segment data becomes unnecessary, that is, a point at which the reproduction of the segment data ends or a point at which it is determined that the segment data will not be reproduced.

In an example shown in FIG. 8, it is assumed that the segment SG42 having the same reproduction time as that of the start segment and the respective segments of the segments S43 and S44 subsequent to the segment SG42 are unnecessary segments since they will not be reproduced, and the segment data of the segments can be discarded.

However, in the client apparatus 11, some of the caches that are supposed to be discarded are retained under another management without being discarded as shown in, for example, FIG. 9. Thus, the segment data of the viewpoints 1 and 2 that have the same reproduction time are retained for a certain period of time.

That is, in the example show in FIG. 9, it is assumed that a viewpoint switching request has been issued during the reproduction of the segment SG41 of the viewpoint 1 like the example shown in FIG. 8, and that the download of the segment data of the segments SG52 and SG53 has been started with the segment SG52 as a start segment.

In this case, in the client apparatus 11, the segment data of the downloaded segments SG52 and SG53 are cached (retained). Further, at the same time, the segment data of the segments S42 and S43 of the viewpoint 1 of the switching source that have the same reproduction time as those of the segments S52 and S53 is also retained without being discarded. In addition, the segment data of some segments including the segment SG44 among the cached segments of the viewpoint 1 is discarded.

That is, some continuous cached segments of the viewpoint 1 including a segment having the same reproduction time as that of the start segment, that is, the segments of the viewpoint 1 within a prescribed period where it is assumed that the time of the start position of the start segment is a start time are retained without being discarded. Further, the segment data of cached segments after the prescribed period of the viewpoint 1 is discarded.

Hereinafter, a cache management method in which the segment data of the segments of a viewpoint 1 of a switching source and the segments of a viewpoint 2 of a switching destination is retained for a prescribed time where it is assumed that the time of the start position of a start segment is a start time as described above will also particularly be called double retention cache management. Further, hereinafter, the period of a reproduction time in which both segment data of viewpoints different from each other and of the same reproduction time is retained (cached) will also be called a double retention period, and the caching of both segment data of a switching source and a switching destination will also be called double caching.

In the client apparatus 11, the double retention cache management is performed as described above, whereby the adjustment of a switching point can be performed so that any position within a double retention period becomes a switching point or effect processing can be performed in the double retention period.

As described above, the download processing and the double retention cache management are performed in the client apparatus 11, whereby the following effects can be obtained.

That is, response speed at the time of switching a viewpoint can be first improved by the download processing and the double retention cache management.

In general, the switching position of a viewpoint is set at the boundary position of the last cached segment of the viewpoint before switching. On the other hand, in the client apparatus 11, the switching of a viewpoint can be performed at the fastest speed at a position halfway through the segment of the viewpoint of a switching destination that has the same reproduction time as that of the segment of the viewpoint of a switching source that is being reproduced.

In this case, the decode of the segment of the switching destination is performed, while the reproduction of the segment of the viewpoint of the switching source that is being reproduced is continuously performed. Then, when a position at which the decode of the segment of the viewpoint of the switching destination is completed catches up with the position of the segment of the viewpoint of the switching source that is being reproduced, that is, when the decode is completed up to a decode complete time reproduction point, it becomes possible to switch the viewpoint of the switching source to the viewpoint of the switching destination.

Note that when a segment is, for example, a video segment, the drawing or the like of an image (video) based on video data obtained by decoding is not required at the time of decoding the segment of the viewpoint of a switching destination before the switching of the viewpoint. Therefore, a decoding operation is allowed at high speed correspondingly.

The decoding operation may be performed at high speed when decoding is started but may be performed at normal speed after the decoding is completed until a decode complete time reproduction point.

Further, when the download and the cache management of segments are separately performed for video and audio constituting a content, the switching of a viewpoint can be performed at the fastest timing for the video and the audio.

However, even if the switching of a viewpoint is separately performed at the fastest timing for video and audio, it cannot be said that the switching is not necessarily substantial from the viewpoint of a comprehensive viewing experience since a deviation occurs in the switching timing between the video and the audio.

On the other hand, the double retention cache management is performed in the client apparatus 11. Therefore, a switching timing, that is, the position of a switching point can be set at almost the same time between video and audio, and a sense of discomfort occurring during switching can be reduced.

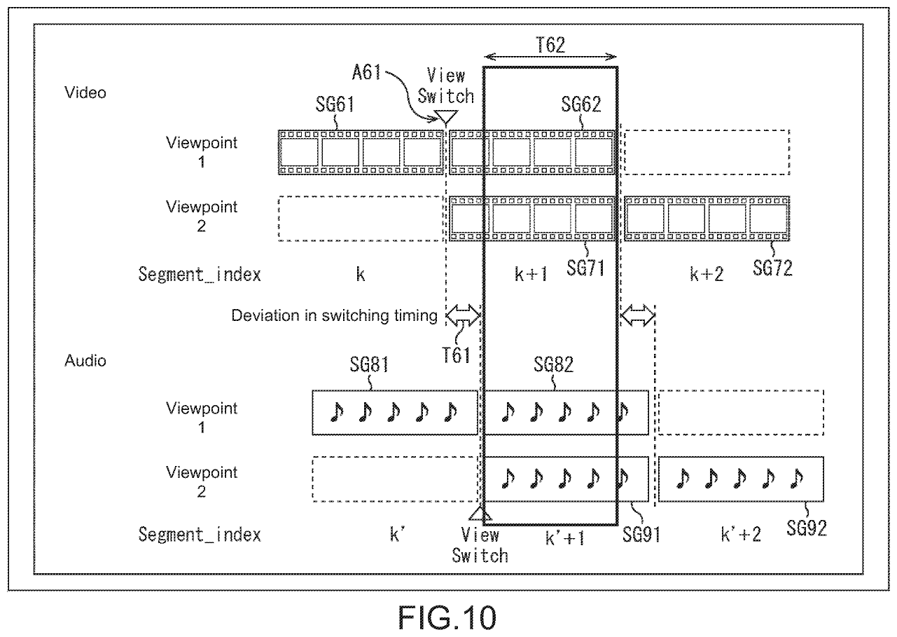

Specifically, as shown in, for example, FIG. 10, it is assumed that a viewpoint switching request has been issued in a state in which segments S61 and S62 of a viewpoint 1 before switching are cached as for the video of a content. Note that in FIG. 10, a horizontal direction indicates a time, that is, a reproduction time, and each square indicates a segment.

At this time, the segment data of segments SG71 and SG72 has been downloaded with the segment SG71 of a viewpoint 2 of a switching destination set as a start segment, and both segment data of the segment SG62 of the viewpoint 1 and the segment SG71 of the viewpoint 2 that have the same reproduction time has been cached.

Further, it is assumed that the viewpoint switching request has been issued in a state in which segments S81 and S82 of the viewpoint 1 before the switching are cached as for the audio of the content, and that a segment SG91 of the viewpoint 2 of the switching destination has been set as a start segment. Further, the segment data of the segments SG91 and SG92 of the viewpoint 2 has been downloaded, and both the segment data of the segment SG82 of the viewpoint 1 and the segment SG91 of the viewpoint 2 that have the same reproduction time has been cached.

At this time, when it is assumed that the start position of the segment SG71 as a start segment is set as a switching point as for the video, and that the start position of the segment SG91 as a start segment is set as a switching point as for the audio, a deviation occurs in the switching between the video and the audio by the portion of a period T61.

Therefore, the client apparatus 11 performs the cache management so that at least some of intervals at which double caching is performed are overlapped with each other between video and audio, and determines a switching point so that the switching point is set at almost the same time between the video and the audio.

In the example of FIG. 10, both the video and the audio are doubly cached in a period T62. Here, the start position of the period T62 corresponds to the start position of the segment SG91, and the end position of the period T62 corresponds to the end position of the segment SG71.

The client apparatus 11 sets a proper position within the period T61 as a switching point for the video, and sets a position at almost the same reproduction time as the switching point for the video within the period T62 as a switching point for the audio. Thus, each of video and audio is switched at a timing at which a user feels as if the video and the audio were switched at almost the same time, and the switching of a viewpoint is realized without a sense of discomfort.

Here, the reason why the switching is performed at almost the same time is that the positions of the switching points cannot be made completely coincident with each other since the video and the audio have different time grids due to a difference in the sample rate between the video and the audio. Therefore, the switching is performed at almost the same time with the obtainable highest accuracy such as accuracy shorter than each sample interval (frame level) of the video and the audio.

Further, since the video data of two systems at the same time called the viewpoints 1 and 2 is ensured (retained) by the double retention cache management, it is possible to perform various transition effects such as cross fade and wipe as video effects.

Note that a video effect is processing in which it generally takes about one second to several seconds to gradually replace video. In this period, the video of two different viewpoints is displayed at the same time, which differs from a situation in which a viewer watches the video of one of the viewpoints.

When audio is switched from the viewpoint of a switching source to the viewpoint of a switching destination in such an effect period, the switching of the viewpoints is not performed at a definite timing but is performed at an indefinite timing to a certain extent. Thus, a user is allowed to visually recognize the switching of the viewpoints and hardly perceive a deviation in the switching between the video and the audio. As a result, a sense of discomfort on a viewing sensation can be reduced. Accordingly, when a video effect is performed, a large sense of discomfort does not occur even if the switching timings of the viewpoints between video and audio are not made strictly coincident with each other.

In addition, since the audio data of the two systems at the same time is retained (ensured) by the double retention cache management, it is possible to perform audio effect processing such as cross fade.

For example, when cross fade is performed, the switching of audio can be realized in which the audio of each viewpoint is synthesized so that the audio of the viewpoint of a switching destination is gradually strengthened while the audio of the viewpoint of a switching source is gradually weakened, and that the audio of the viewpoint of the switching source is finally smoothly switched to the audio of the viewpoint of the switching destination.

Thus, instantaneous audio discontinuity at the time of switching a viewpoint can be avoided, and the generation of noise can be reduced. Note that even if the audio of the viewpoint of a switching source and the audio of the viewpoint of a switching destination are discontinuous, noise may not be generated in some cases.

<Description of Download Processing>

Subsequently, the processing performed by the client apparatus 11 shown in FIG. 3 will be described.

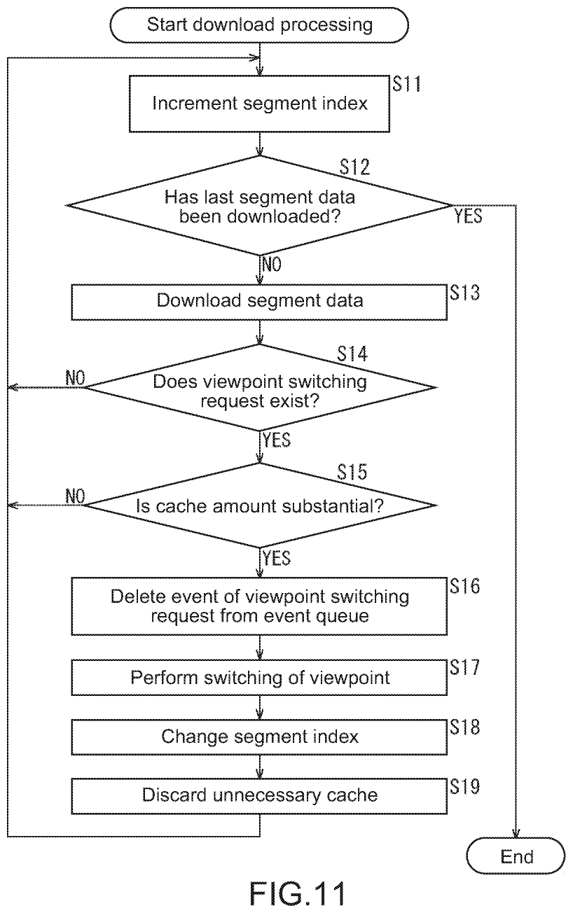

First, the download processing by the client apparatus 11 will be described with reference to the flowchart of FIG. 11.

The download processing is started when the start of the reproduction of a content is instructed. At this time, when the content is composed of video and audio, the download processing is separately performed for each of the video and the audio to download the segment data of the video and the audio.

In this case, the HTTP download manager 23 sets the value of a segment to be downloaded, that is, the value of a segment index for identifying segment data at zero.

In step S11, the HTTP download manager 23 increments the value of the segment index by one.

In step S12, the HTTP download manager 23 determines whether the last segment data has been downloaded on the basis of the segment index.

When it is determined in step S12 that the last segment data has been downloaded, that is, when all the segment data of the content has been downloaded, the download processing is ended.

On the other hand, when it is determined in step S12 that the last segment data has not been downloaded, the HTTP download manager 23 downloads segment data indicated by the segment index in step S13.

That is, the HTTP download manager 23 requests the server to send the segment data. Then, the HTTP download manager 23 receives the segment data sent from the server in response to the request and supplies the received segment data to the retention units 25 to be retained. Thus, the segment data of one viewpoint or the segment data of two viewpoints before and after switching is retained in the retention units 25.

As described above, the HTTP download manager 23 downloads the data (segment data) of the content for each in units of a segment, that is, for each segment. Note that a source from which the segment data is acquired is not limited to the server but may include any form such as a recording medium.

In step S14, the HTTP download manager 23 determines whether a viewpoint switching request exists in the event queue of the memory 22.

When it is determined in step S14 that the viewpoint switching request does not exist, the processing returns to step S11 to repeatedly perform the above processing.

On the other hand, when it is determined in step S14 that the viewpoint switching request exists, the HTTP download manager 23 determines whether a cache amount of the viewpoint of a switching source is substantial in step S15.

For example, in step S15, when the switching of the viewpoints of the video and the audio is performed at almost the same time, it is determined that the cache amount is substantial if the cache of the segment data of the switching source exists to such an extent that a double retention period having a substantial length overlapped between the video and the audio can be ensured.

Note that a substantial cache amount is varied depending on the content of processing performed by the client apparatus 11 in the reproduction of the content.

For example, when cross fade is performed for two seconds as a video effect at the time of switching a viewpoint, it is determined that a cache amount is substantial if the cache of the segment data of the viewpoint of a switching source exists to such an extent that a double retention period can be ensured for the two seconds. In this case, the cache of segment data after the two seconds of the viewpoint of the switching source may be discarded.

When it is determined in step S15 that the cache amount is not substantial, the processing returns to step S11 to repeatedly perform the above processing.

On the other hand, when it is determined in step S15 that the cache amount is substantial, the HTTP download manager 23 deletes the event of the viewpoint switching request from the event queue of the memory 22 in step S16.

In step S17, the HTTP download manager 23 performs the switching of a viewpoint.

That is, the HTTP download manager 23 changes an adaptation set and a representation to be downloaded.

In this case, the HTTP download manager 23 selects an adaptation set corresponding to the viewpoint of a switching destination indicated by the viewpoint switching request existing in the event queue as an adaptation set after the change.

Further, the HTTP download manager 23 selects, from among the representations of the adaption set after the change, a representation having a proper bit rate as a representation after the change on the basis of the status of a network, the resolution of desired video, the cache amount of the segment data of the viewpoint of the switching source, or the like.

In this case, as described above, the selection of representations may be performed in such a manner that a representation having a bit rate lower than that of a representation before switching is selected at the time of performing the switching, then a representation having a higher bit rate is gradually selected, and finally a representation having the same bit rate as that of the representation before the switching is selected.

In step S18, the HTTP download manager 23 changes the value of the segment index that indicates segment data to be downloaded.

That is, for example, the HTTP download manager 23 determines a switching point, a start segment, and a double retention period in consideration of both video and audio as described with reference to FIGS. 4 to 7 and FIG. 10.

Specifically, a switching point, a start segment, and a double retention period are determined on the basis of, for example, a cache amount of the segment data of a reproduction point or the viewpoint of a switching source for both video and audio, a reproduction time dur_vp1, a download time dur_vp2, a decode time dur_vp3, the presence or absence of a video effect, the presence or absence of an audio effect, the bit rate of a segment, or the like. Here, as described above, it can be said that the determination (selection) of a start segment is to select a reproduction time as a start time for a download, that is, the start position of the start segment.

More specifically, since there is a case in which it is required to consider the bit rate or the like of a segment to determine a start segment, the processing of step S17 and the processing of step S18 are performed at the same time.

When the start segment is determined as described above, the HTTP download manager 23 changes the value of the segment index so that the value of the segment index becomes a value indicating a segment temporally previous to the determined start segment. Thus, in the next step S13, the segment data of the start segment as for the representation of the adaptation set after the change is downloaded.

In step S19, the HTTP download manager 23 discards an unnecessary cache of the viewpoint of the switching source retained in the retention units 25.

That is, for example, among the segment data of the viewpoint of the switching source retained in the retention units 25, the HTTP download manager 23 discards segment data at a reproduction time after the double retention period determined in step S18 as an unnecessary cache. That is, the segment data regarded as the unnecessary cache is deleted from the retention units 25.

Note that the discard of the unnecessary cache may be performed at a timing before the download of the segment data of the viewpoint of the switching destination is started or a timing after the download is started.

After the unnecessary cache is discarded as described above, the processing returns to step S11 to repeatedly perform the above processing.

In the manner described above, the client apparatus 11 determines a switching point or a start segment on the basis of a cache amount of the like of the segment data of a reproduction point or the viewpoint of a switching source and downloads the segment data of the viewpoint of a switching destination.

Thus, the switching of the viewpoint of an actual content can be more quickly performed while properly ensuring a necessary cache in response to a viewpoint switching operation by a user. That is, response speed at the time of switching a stream can be increased. Further, the switching of video and audio can be performed at substantially the same time with consideration given to both the video and the audio at the time of determining a switching point, a start segment, or the like.

<Description of Decode Processing>

When the download processing described with reference to FIG. 11 is performed for video and audio, the segment data of the video and the audio is cached (stored) in the retention units 25. Then, the client apparatus 11 performs decode processing that is processing for decoding the cached segment data to reproduce a content.

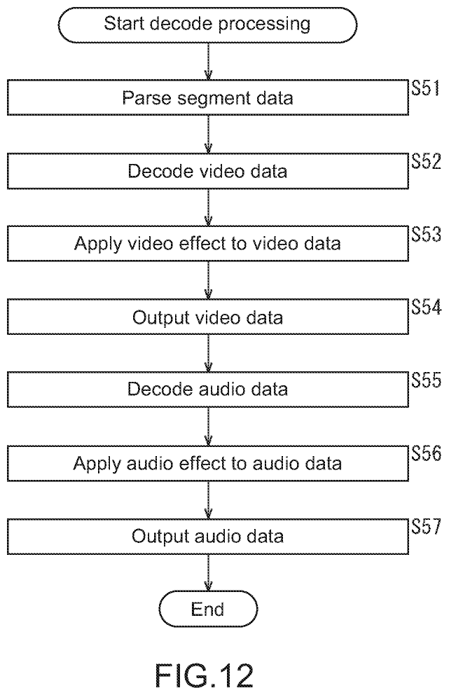

Hereinafter, the decode processing by the client apparatus 11 will be described with reference to the flowchart of FIG. 12.

In step S51, the segment parser 26 parses segment data retained in the retention units 25.

That is, for example, at a reproduction time outside a double retention period, the segment parser 26 reads segment data from a retention unit 25 corresponding to a viewpoint that is being reproduced among the retention units 25-1 and 25-2, extracts video data from the segment data, and supplies the extracted video data to the video decoders 27.

At the same time, the segment parser 26 reads segment data from a retention unit 25 corresponding to the viewpoint that is being reproduced among the retention units 25-3 and 25-4, extracts audio data from the segment data, and supplies the extracted audio data to the audio decoders 29.

On the other hand, at a reproduction time within the double retention period, the segment parser 26 reads segment data from each of the retention units 25-1 and 25-2, extracts video data from each of the segment data, and supplies the extracted video data to the video decoders 27-1 and 27-2.

At the same time, the segment parser 26 reads segment data from each of the retention units 25-3 and 25-4, extracts audio data from each of the segment data, and supplies the extracted audio data to the audio decoders 29-1 and 29-2.

In step S52, the video decoders 27 decode the video data supplied from the segment parser 26 and supplies the decoded video data to the video effector 28.

For example, as for the reproduction time beyond the double retention period, only the video data of the viewpoint that is being reproduced is decoded and supplied to the video effector 28. On the other hand, as for the reproduction time within the double retention period, both the video data of the viewpoint of a switching source and the video data of the viewpoint of a switching destination are decoded and supplied to the video effector 28.

As described above, the video decoders 27-1 and 27-2 are used in parallel in the double retention period.

In step S53, the video effector 28 applies a video effect to the video data supplied from the video decoders 27.

That is, the video effector 28 performs effect processing such as cross fade processing and wipe processing on the video data in a period in which the video effect is applied on the basis of the video data of the viewpoint of the switching source and the video data of the viewpoint of the switching destination to generate video data for presentation. That is, the video data of an effect moving image, in which display transitions from the video of the viewpoint of the switching source to the video of the viewpoint of the switching destination to which the video effect has been applied, is generated as the video data for presentation.

On the other hand, as for a period in which the video effect is not applied, the video effector 28 directly uses the video data of the viewpoint that is being reproduced as the video data for presentation. For example, if the double retention period is a reproduction time at which the video effect is not applied, the video data of the viewpoint that is being reproduced among the viewpoint of the switching source and the viewpoint of the switching destination is used as the video data for presentation.

In step S54, the video effector 28 outputs the video data for presentation obtained in the processing of step S53 to a subsequent stage.

For example, the video effector 28 outputs the video data of an effect moving image as the video data for presentation in an effect period. Further, for example, at the end of the effect period, the video effector 28 switches the video data for presentation that is to be output from the video data of an effect moving image to the video data of the viewpoint of the switching destination.

In addition, for example, when the video effect is not performed, the video effector 28 switches the video data for presentation that is to be output from the video data of the viewpoint of the switching source to the video data of the viewpoint of the switching destination at a switching point.

In step S55, the audio decoders 29 decode the audio data supplied from the segment parser 26 and supply the decoded audio data to the audio effector 30.

For example, as for the reproduction time outside the double retention period, only the audio data of the viewpoint that is being reproduced is decoded and supplied to the audio effector 30. On the other hand, as for the reproduction time within the double retention period, both the audio data of the viewpoint of the switching source and the audio data of the viewpoint of the switching destination are decoded and supplied to the audio effector 30.

Note that the audio decoders 29-1 and 29-2 are used in parallel in the double retention period.

In step S56, the audio effector 30 applies an audio effect to the audio data supplied from the audio decoders 29.

That is, for example, the audio effector 30 performs effect processing such as cross fade on the audio data in a period in which the effect is applied on the basis of the audio data of the viewpoint of the switching source and the audio data of the viewpoint of the switching destination that has the same reproduction time as that of the audio data to generate audio data for presentation. Thus, for example, the audio data of effect audio in which the audio of the viewpoint of the switching source is faded out and the audio of the viewpoint of the switching destination is faded in is obtained as the audio data for presentation.

On the other hand, as for a period in which the audio effect is not applied, the audio effector 30 directly uses the audio data of the viewpoint that is being reproduced as the audio data for presentation. For example, if the double retention period is a reproduction time at which the audio effect is not applied, the audio data of the viewpoint that is being reproduced among the viewpoint of the switching source and the viewpoint of the switching destination is used as the audio data for presentation.

In step S57, the audio effector 30 outputs the audio data for presentation obtained in the processing of step S56 to a subsequent stage to end the decode processing.

For example, the audio effector 30 outputs the audio data of effect audio as the audio data for presentation in an effect period. Further, for example, at the end of the effect period, the audio effector 30 switches the audio data for presentation that is to be output from the audio data of the effect audio to the audio data of the viewpoint of the switching destination.

In addition, for example, when the audio effect is not performed, the audio effector 30 switches the audio data for presentation that is to be output from the audio data of the viewpoint of the switching source to the audio data of the viewpoint of the switching destination at a switching point.

Note that at the time of switching a viewpoint, the video effector 28 and the audio effector 30 control the switching of the output of video data and audio data so that timings for switching the output from the viewpoint of the switching source to the viewpoint of the switching destination become substantially the same between the video data and the audio data.

Further, more specifically, the processing of steps S52 to S54 and the processing of steps S55 to S57 are performed in parallel.

In the manner described above, the client apparatus 11 decodes video data and audio data, appropriately performs effect processing on the video data and the audio data to generate video data and audio data for presentation, and outputs the generated video data and the audio data.

By properly applying an effect to video data or audio data, the client apparatus 11 can reduce a user's sense of discomfort on a viewing sensation.

<Configuration Example of Computer>

Meanwhile, the above series of processing can be performed not only by hardware but also by software. When the series of processing is performed by software, a program constituting the software is installed in a computer. Here, examples of the computer include a computer incorporated in dedicated hardware and a general-purpose personal computer capable of performing various functions with the installation of various programs.

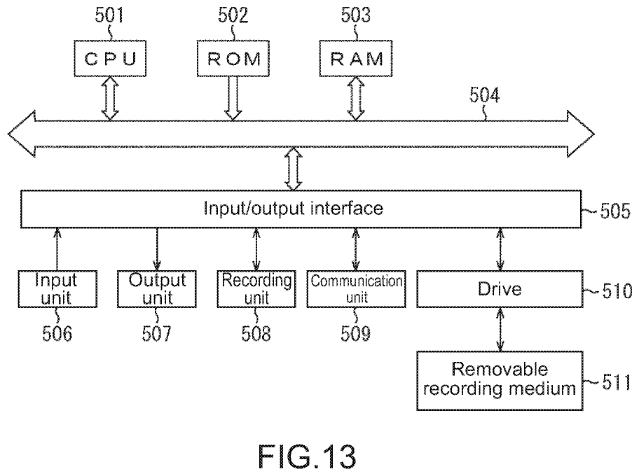

FIG. 13 is a block diagram showing a configuration example of the hardware of a computer that performs the above series of processing according to a program.

In the computer, a CPU (Central Processing Unit) 501, a ROM (Read Only Memory) 502, and a RAM (Random Access Memory) 503 are connected to one another via a bus 504.

In addition, an input/output interface 505 is connected to the bus 504. An input unit 506, an output unit 507, a recording unit 508, a communication unit 509, and a drive 510 are connected to the input/output interface 505.

The input unit 506 is composed of a keyboard, a mouse, a microphone, an imaging element, or the like. The output unit 507 is composed of a display, a speaker array, or the like. The recording unit 508 is composed of a hard disk, a non-volatile memory, or the like. The communication unit 509 is composed of a network interface or the like. The drive 510 drives a removable recording medium 511 such as a magnetic disk, an optical disk, a magnetic optical disk, and a semiconductor memory.

In the computer configured as described above, the CPU 501 loads, for example, a program recorded on the recording unit 508 into the RAM 503 via the input/output interface 505 and the bus 504 to be performed to perform the above series of processing.

The program performed by the computer (the CPU 501) can be recorded on, for example, the removable recording medium 511 serving as a package medium or the like to be provided. Further, the program can be provided via a wired or wireless transmission medium such as a local area network, the Internet, and digital satellite broadcasting.

In the computer, the program can be installed in the recording unit 508 via the input/output interface 505 by the attachment of the removable recording medium 511 to the drive 510. Further, the program can be received by the communication unit 509 via a wired or wireless transmission medium and installed in the recording unit 508. Besides, the program can be installed in advance in the ROM 502 or the recording unit 508.

Note that the program performed by the computer may be a program that is chronologically processed in order described in the present specification, or may be a program that is processed in parallel or at a required timing such as when invoked.

Further, the embodiments of the present technology are not limited to the above embodiments but may be modified in various ways without departing from the spirit of the present technology.

For example, the present technology can employ the configuration of cloud computing in which one function is shared and cooperatively processed between a plurality of apparatuses via a network.

Further, the respective steps described in the above flowcharts can be performed not only by one apparatus but also by a plurality of apparatus in a shared fashion.

In addition, when one step includes a plurality of processing, the plurality of processing included in the one step can be performed not only by one apparatus but also by a plurality of apparatuses in a shared fashion.

Further, the effects described in the present specification are given only for illustration and are not limitative. Other effects may be produced.

In addition, the present technology can also employ the following configurations.

(1) An image processing apparatus including:

a retention unit that retains, when performing switching of reproduction from reproduction based on first reproduction data to reproduction based on second reproduction data different from the first reproduction data, the first reproduction data from a reproduction time under reproduction that has been acquired to a prescribed reproduction time and the second reproduction data on and after a start time in which a reproduction time from the reproduction time under the reproduction of the first reproduction data to a last reproduction time of the first reproduction data that has been acquired is acquired as the start time.

(2) The image processing apparatus according to (1), further including:

an acquisition unit that acquires the second reproduction data on and after the start time.

(3) The image processing apparatus according to (1) or (2), wherein

the retention unit discards the first reproduction data of a reproduction time after the prescribed reproduction time before or after starting acquisition of the second reproduction data.

(4) The image processing apparatus according to any one of (1) to (3), wherein

the first reproduction data and the second reproduction data are reproduction data having a same content and viewpoints different from each other.

(5) The image processing apparatus according to any one of (1) to (4), wherein

the first reproduction data and the second reproduction data are video data or audio data.

(6) The image processing apparatus according to (2), wherein

the acquisition unit acquires the second reproduction data for each prescribed time unit.

(7) The image processing apparatus according to (6), wherein

the prescribed time unit is a segment.

(8) The image processing apparatus according to (6) or (7), wherein

the acquisition unit selects the start time so that a time required to acquire the second reproduction data in the prescribed time unit with the start time as a start becomes shorter than the reproduction time of the first reproduction data from the reproduction time under the reproduction to the start time.

(9) The image processing apparatus according to (6) or (7), wherein

the acquisition unit acquires the second reproduction data with a start position of synchronous reproduction data as the start time when a sum of a time required to acquire the synchronous reproduction data that is the second reproduction data in the prescribed time unit that has a same reproduction time as the first reproduction data in the prescribed time unit under reproduction and a time required until decode of the synchronous reproduction data catches up with the reproduction of the first reproduction data after the acquisition of the synchronous reproduction data is shorter than a reproduction time from the reproduction time under the reproduction to an end of the reproduction of the first reproduction data in the prescribed time unit under the reproduction.

(10) The image processing apparatus according to any one of (6) to (9), wherein

the acquisition unit acquires the second reproduction data having a bit rate lower than a bit rate of the first reproduction data under reproduction as the second reproduction data in the prescribed time unit with the start time as a start, and then acquires the second reproduction data having a higher bit rate in the prescribed time unit so that the bit rate of the acquired second reproduction data gradually increases.

(11) The image processing apparatus according to (2), further including:

an output unit that switches output reproduction data from the first reproduction data to the second reproduction data at a reproduction time between the reproduction time under the reproduction and the prescribed reproduction time.

(12) The image processing apparatus according to (11), wherein

the output unit performs control so that a timing for switching an output from the first reproduction data to the second reproduction data as video data and a timing for switching an output from the first reproduction data to the second reproduction data as audio data become substantially same.

(13) The image processing apparatus according to (12), wherein

the acquisition unit performs control so that at least parts of periods in which the first reproduction data and the second reproduction data at a same reproduction time are retained are overlapped with each other between the video data and the audio data.

(14) The image processing apparatus according to any one of (1) to (10), further including:

an output unit that performs effect processing on a basis of the first reproduction data and the second reproduction data at a same reproduction time that are retained in the retention unit, and outputs reproduction data obtained by the effect processing.

(15) An image processing method including:

a step of retaining, when performing switching of reproduction from reproduction based on first reproduction data to reproduction based on second reproduction data different from the first reproduction data, the first reproduction data from a reproduction time under reproduction that has been acquired to a prescribed reproduction time and the second reproduction data on and after a start time in which a reproduction time from the reproduction time under the reproduction of the first reproduction data to a last reproduction time of the first reproduction data that has been acquired is acquired as the start time.

(16) A program causing a computer to perform processing including: a step of

retaining, when performing switching of reproduction from reproduction based on first reproduction data to reproduction based on second reproduction data different from the first reproduction data, the first reproduction data from a reproduction time under reproduction that has been acquired to a prescribed reproduction time and the second reproduction data on and after a start time in which a reproduction time from the reproduction time under the reproduction of the first reproduction data to a last reproduction time of the first reproduction data that has been acquired is acquired as the start time.

### REFERENCE SIGNS LIST

1 client apparatus
23 HTTP download manager
25-1 to 25-4, 25 retention unit
26 segment parser
27-1, 27-2, 27 video decoder
28 video effector
29-1, 29-2, 29 audio decoder
30 audio effector

1. An image processing apparatus, comprising:
an acquisition unit that acquires, when performing switching of reproduction from reproduction based on first reproduction data to reproduction based on second reproduction data different from the first reproduction data, the second reproduction data on and after a start time for each prescribed time unit with a start position of synchronous reproduction data as the start time when a sum of a time required to acquire the synchronous reproduction data that is the second reproduction data in the prescribed time unit that has a same reproduction time as the first reproduction data in the prescribed time unit under reproduction and a time required until decode of the synchronous reproduction data catches up with the reproduction of the first reproduction data after the acquisition of the synchronous reproduction data is shorter than a reproduction time from a reproduction time under the reproduction to an end of the reproduction of the first reproduction data in the prescribed time unit under the reproduction; and
a retention unit that retains the first reproduction data from the reproduction time under reproduction that has been acquired to a prescribed reproduction time and the second reproduction data on and after the start time.

2. The image processing apparatus according to claim 1, wherein:
the acquisition unit acquires the second reproduction data having a bit rate lower than a bit rate of the first reproduction data under reproduction as the second reproduction data in the prescribed time unit with the start time as a start, and then acquires the second reproduction data having a higher bit rate in the prescribed time unit so that the bit rate of the acquired second reproduction data gradually increases.

3. The image processing apparatus according to claim 1, wherein
the retention unit discards the first reproduction data of a reproduction time after the prescribed reproduction time before or after starting acquisition of the second reproduction data.

4. The image processing apparatus according to claim 1, wherein
the first reproduction data and the second reproduction data are reproduction data having a same content and viewpoints different from each other.

5. The image processing apparatus according to claim 1, wherein
the first reproduction data and the second reproduction data are video data or audio data.

6. (canceled)

7. The image processing apparatus according to claim 1, wherein the prescribed time unit is a segment.

8. (canceled)

9. (canceled)

10. (canceled)

11. The image processing apparatus according to claim 1, further comprising:
an output unit that switches output reproduction data from the first reproduction data to the second reproduction data at a reproduction time between the reproduction time under the reproduction and the prescribed reproduction time.

12. The image processing apparatus according to claim 11, wherein
the output unit performs control so that a timing for switching an output from the first reproduction data to the second reproduction data as video data and a timing for switching an output from the first reproduction data to the second reproduction data as audio data become substantially same.

13. The image processing apparatus according to claim 12, wherein
the acquisition unit performs control so that at least parts of periods in which the first reproduction data and the second reproduction data at a same reproduction time are retained are overlapped with each other between the video data and the audio data.

14. The image processing apparatus according to claim 1, further comprising:
an output unit that performs effect processing on a basis of the first reproduction data and the second reproduction data at a same reproduction time that are retained in the retention unit, and outputs reproduction data obtained by the effect processing.

15. An image processing method, comprising steps of:
acquiring, when performing switching of reproduction from reproduction based on first reproduction data to reproduction based on second reproduction data different from the first reproduction data, the second reproduction data on and after a start time for each prescribed time unit with a start position of synchronous reproduction data as the start time when a sum of a time required to acquire the synchronous reproduction data that is the second reproduction data in the prescribed time unit that has a same reproduction time as the first reproduction data in the prescribed time unit under reproduction and a time required until decode of the synchronous reproduction data catches up with the reproduction of the first reproduction data after the acquisition of the synchronous reproduction data is shorter than a reproduction time from a reproduction time under the reproduction to an end of the reproduction of the first reproduction data in the prescribed time unit under the reproduction; and
retaining the first reproduction data from the reproduction time under reproduction that has been acquired to a prescribed reproduction time and the second reproduction data on and after the start time.

16. A program causing a computer to perform processing comprising steps of:
acquiring, when performing switching of reproduction from reproduction based on first reproduction data to reproduction based on second reproduction data different from the first reproduction data, the second reproduction data on and after a start time for each prescribed time unit with a start position of synchronous reproduction data as the start time when a sum of a time required to acquire the synchronous reproduction data that is the second reproduction data in the prescribed time unit that has a same reproduction time as the first reproduction data in the prescribed time unit under reproduction and a time required until decode of the synchronous reproduction data catches up with the reproduction of the first reproduction data after the acquisition of the synchronous reproduction data is shorter than a reproduction time from a reproduction time under the reproduction to an end of the reproduction of the first reproduction data in the prescribed time unit under the reproduction; and
retaining the first reproduction data from the reproduction time under reproduction that has been acquired to a prescribed reproduction time and the second reproduction data on and after the start time.
